(19) United States
(12) Patent Application Publication
(10) Pub. No.: US 2025/0059710 A1
(43) Pub. Date: Feb. 20, 2025

(54) CELLULOSE-BASED GAS BARRIER FILM

(71) Applicant: Stora Enso OYJ, Helsinki (FI)

(72) Inventors: Isto Heiskanen, Imatra (FI); Kaj Backfolk, Lappeenranta (FI); Anna Kauppi, Lappeenranta (FI); Katja Lyytikäinen, Imatra (FI); Cecilia Land Hensdal, Forshaga (SE); Anders Moberg, Hammarö (SE)

(73) Assignee: Stora Enso OYJ, Helsinki (FI)

(21) Appl. No.: 18/717,642

(22) PCT Filed: Dec. 12, 2022
(86) PCT No.: PCT/IB2022/062047

§ 371 Date: Jun. 7, 2024

(30) Foreign Application Priority Data
Dec. 15, 2021 (SE) 2151534-1

(51) Int. Cl. D21H 11/18; B32B 29/00; B65D 65/40; D21H 27/10

(52) U.S. Cl. CPC D21H 11/18; B32B 29/005; B65D 65/40; D21H 27/10; B32B 2250/02; B32B 2250/26; B32B 2255/12; B32B 2255/26; B32B 2307/7244; B32B 2553/00; B65D 2565/387

(57) ABSTRACT

The present invention relates to a cellulose-based gas barrier film, said cellulose-based gas barrier film comprising at least 50 wt % of a fines-depleted highly refined cellulose pulp (FD-HRC), wherein said FD-HRC has a Schopper-Riegler (SR) number in the range of 80-100 as determined by standard ISO 5267-1, wherein said FD-HIRC has an amount of long (>0.2 mm) fibers of at least 8 million fibers per gram (based on dry weight), and wherein said FD-HRC has a Fines A value below 46%, wherein the Fines A value is determined using an FS5 optical fiber analyzer. The present invention relates to a method for manufacturing said cellulose-based gas barrier film.

### TECHNICAL FIELD

The present disclosure relates to methods for preparing a gas barrier film comprising a highly refined cellulose pulp such as a microfibrillated cellulose.

### BACKGROUND

Effective gas, aroma, and/or moisture barriers are required in packaging industry for shielding sensitive products. Particularly, oxygen-sensitive products require an oxygen barrier to extend their shelf-life. Oxygen-sensitive products include many food products, but also pharmaceutical products and electronic industry products. Known packaging materials with oxygen barrier properties may be comprised of one or several polymer films or of a fibrous paper or board coated with one or several layers of an oxygen barrier polymer, usually as part of a multilayer coating structure. Another important property for packaging for food products is resistance to grease and oil.

More recently, films produced from highly refined cellulose and microfibrillated cellulose (MFC) have been developed, in which defibrillated cellulosic fibrils have been suspended e.g. in water, re-organized and rebonded together to form a continuous film. Such films have been found to provide good gas barrier properties as well as good resistance to grease and oil.

The films can be made by applying a highly refined cellulose pulp suspension on a porous substrate forming a web followed by dewatering of the web by draining water through the substrate for forming the film. Formation of the web can be accomplished e.g. by use of a paper-or paperboard machine type of process. The porous substrate may for example be a membrane or wire fabric or it can be a paper or paperboard substrate.

Manufacturing of films and barrier substrates from highly refined cellulose or MFC suspensions on a paper machine is difficult because of the high water retention and/or high drainage resistance of the suspensions and the formed webs. Rapid or forced dewatering, e.g. assisted by pressure or suction tends to lead to high loss of fines from the web, or uneven vertical distribution of fines in the web, and formation of pinholes, resulting in a film with poor barrier properties. On the other hand, reducing the dewatering speed to prevent these problems will require excessively long dewatering sections.

Another problem with webs and films formed from highly refined cellulose or MFC suspensions is that they will typically exhibit poor tear strength.

From a technical and economical point of view, it would be preferable to find a solution that enables fast dewatering, and at the same time improves the film barrier and strength properties.

### DESCRIPTION OF THE INVENTION

It is an object of the present disclosure to provide a highly refined cellulose pulp suitable for manufacturing a barrier film in a paper-or paperboard machine type of process.

It is a further object of the present disclosure to provide a highly refined cellulose pulp suitable for manufacturing a barrier film based on renewable raw materials.

It is a further object of the present disclosure to provide a method for treating highly refined cellulose pulp, which alleviates at least some of the above-mentioned problems.

It is a further object of the present disclosure to provide a method for decreasing the water retention and/or increasing the homogeneity of a highly refined cellulose pulp.

The above-mentioned objects, as well as other objects as will be realized by the skilled person in the light of the present disclosure, are achieved by the various aspects of the present disclosure.

The present invention is based on the realization that a relatively small portion of fines, including fine cellulosic particles and dissolved and colloidal substances, in highly refined cellulose pulp suspensions is responsible to a high degree for the high water retention and/or high drainage resistance of the suspensions and the formed webs. Traditionally, when manufacturing barrier films it has been considered important to try to retain as much of the fines as possible in the web, as the fines are also responsible to a high degree for the barrier properties of the finished films. Accordingly, previous strategies for manufacturing barrier films from highly refined cellulose pulp have focused on measures for retaining the fines in the web during forming and dewatering, such as addition of chemical retention agents.

The inventive gas barrier films and methods use a highly refined cellulose pulp (HRC), such as a microfibrillated cellulose (MFC), which has been subjected to fractionation to remove some of the fines in the highly refined cellulose pulp.

According to a first aspect illustrated herein, there is provided a cellulose-based gas barrier film, said cellulose-based gas barrier film comprising

at least 50 wt % of a fines-depleted highly refined cellulose pulp (FD-HRC),

wherein said FD-HRC has a Schopper-Riegler (SR) number in the range of 80-100 as determined by standard ISO 5267-1.

Preferably, said FD-HRC has an amount of long (>0.2 mm) fibers of at least 8 million fibers per gram (based on dry weight), and

a Fines A value below 46%, wherein the Fines A value is determined using an FS5 optical fiber analyzer.

In some embodiments, the term highly refined cellulose pulp as used herein refers to a cellulose pulp which has been subjected to considerable refining, but not to the extent that all of the cellulose pulp will pass through a 200 mesh screen (equivalent hole diameter 76 um) of a conventional laboratory fractionation device (SCAN-CM 66:05). Preferably no more than 60% of the highly refined cellulose pulp will pass through a 200 mesh screen of a conventional laboratory fractionation device according to SCAN-CM 66:05. More preferably no more than 50% of the highly refined cellulose pulp will pass through a 200 mesh screen of a conventional laboratory fractionation device according to SCAN-CM 66:05. In some embodiments, 5-60% and more preferably 10-50 wt % of the highly refined cellulose pulp will pass through a 200 mesh screen of a conventional laboratory fractionation device according to SCAN-CM 66:05. Thus, the highly refined cellulose pulp will comprise a mixture of finer particles and coarser particles. The size distribution of the particles in the highly refined cellulose pulp may depend on the starting material and the refining processes used.

The term fines as used herein generally refers to fine cellulosic particles, which pass through a 200 mesh screen (equivalent hole diameter 76 um) of a conventional laboratory fractionation device (SCAN-CM 66:05). There are two major types of fiber fines, namely primary and secondary fines. Primary fines are generated during pulping and bleaching, where they are removed from the cell wall matrix by chemical and mechanical treatment. As a consequence of their origin (i.e., compound middle lamella, ray cells, parenchyma cells), primary fines exhibit a flake-like structure with only minor shares of fibrillar material. In contrast, secondary fines are generated during the refining of pulp. Both primary and secondary fines have a negative influence on dewatering in the forming section of a paper machine. The fines may also comprise dissolved and colloidal substances. The dissolved substances typically consist of ions and molecules having dimensions less than 0.1 μm, e.g. soluble polyelectrolytes such as hemicelluloses, pectins, and lignin fragments. The colloidal substances consist of dispersed particles about 0.1 to 1 μm, e.g. wood pitch, latex (from coated broke), and microfines. Because of their large specific surface area in comparison to pulp fibers, and their chemical composition and anionic charge, fines also consume a high proportion of chemical additives used in pulp and paper production.

The term “fines-depleted” as used herein denotes that at least some of the fines, including fine cellulosic particles and/or dissolved and colloidal substances, in the highly refined cellulose pulp have been removed. The removal changes the particle size distribution such that the FD-HRC has a lower portion of fine cellulosic particles and/or dissolved and colloidal substances than the HRC. The particle size distribution of the removed fines may depend on the composition of the HRC and the method used for removal. For example, the fines removed from a very highly refined cellulose pulp, such as a microfibrillated cellulose (MFC) may comprise mainly very fine fines and dissolved and colloidal substances, whereas the fines removed from a less highly refined cellulose pulp may comprise a larger portion of fiber fines, such as primary and secondary fines.

As the starting material is a highly refined cellulose pulp, the removed fines may typically be comprised mainly of fibrils, fibril agglomerates, and or fibril bundles generated during the refining of the pulp.

The composition of fines in the HRC and FD-HRC of the present disclosure May advantageously be represented by the parameters Fines A and Fines B, as measured using the FS5 optical fiber analyzer (Valmet). The FS5 optical fiber analyzer typically does not register dissolved and colloidal substances.

The term “Fines A” as used herein refers to flake-like fines with a size under 0.2 mm (length<0.2 mm and width<0.2 mm). The projection area of the flake-like fines divided by the total fiber projection area*100%=Fines A.

The term “Fines B” as used herein refers to lamella-like long fines having a width of less than 5 μm and a length over 0.2 mm. The length of these objects divided by the length of all objects with length>0.2 mm*100%=Fines B.

The FD-HRC, having both a high SR value, a high amount of fibers having a length>0.2 mm, and a Fines A value below 46%, has been found to be very useful for manufacturing gas barrier films as it gives faster dewatering and at the same time improves the film barrier and retains tensile strength properties as compared to unfractionated HRC or MFC.

The fines removed are also expected to have very poor wire retention, especially in fast board/paper machines. The poor wire retention will lead to fines accumulation in the white waters, causing poor dewatering, foaming, formation of deposits into the systems, and microbiological problems reducing the overall efficiency of the board/paper production.

The term film as used herein refers generally to a thin continuous sheet formed material. Depending on its composition, purpose and properties, the film can also be considered as a thin paper or even as a membrane.

The gas barrier film comprises at least 50 wt % of a fines-depleted highly refined cellulose pulp (FD-HRC). The gas barrier film may be comprised solely of the FD-HRC or of a combination of the FD-HRC and one or more other components. In some embodiments, the gas barrier film comprises at least 70 wt %, preferably at least 90 wt %, of the FD-HRC. In some embodiments, the gas barrier film comprises in the range of 50-99 wt %, preferably in the range of 70-99 wt %, more preferably in the range of 80-99 wt %, and more preferably in the range of 90-99 wt % of FD-HRC, based on the total dry weight of the gas barrier film. The other components of the gas barrier film may for example include conventional (i.e. non-fines depleted) HRC or less refined cellulose pulp. The gas barrier film may further comprise additives such as native starch or starch derivatives, cellulose derivatives such as sodium carboxymethyl cellulose, fillers, dispersing agents, drainage and/or retention additives, deflocculating additives, dry strength additives, softeners, cross-linking aids, sizing chemicals, dyes and colorants, wet strength resins, fixatives, de-foaming aids, microbe and slime control aids, or mixtures thereof. The inventive manufacturing method provides an alternative way of increasing dewatering speed, which is less dependent on the addition of retention and drainage chemicals, but retention and drainage chemicals may still be used. In some embodiments, the gas barrier film is free from added retention and drainage chemicals.

The gas barrier film preferably comprises no more than 30 wt % of additives in total, based on the total dry weight of the gas barrier film. More preferably the gas barrier film comprises no more than 20 wt % or 10 wt % of additives in total, based on the total dry weight of the gas barrier film.

The FD-HRC is a highly refined cellulose pulp from which some of the fines have been removed by fractionation in order to obtain a highly refined cellulose pulp depleted in fines. Thus, the FD-HRC is based on a refined cellulose fiber composition. Refining, or beating, of cellulose pulps refers to mechanical treatment and modification of the cellulose fibers in order to provide them with desired properties. Refining, or beating, of cellulose pulps also leads to the formation of “fines” in the highly refined cellulose pulp.

Subsequent to the refining, the highly refined cellulose pulp has been subjected to fractionation to remove some of the fines to obtain a fines-depleted highly refined cellulose pulp (FD-HRC). In some embodiments, 0.2-4 wt %, preferably by 1-3 wt %, and more preferably by 1.5-2.5 wt %, of the total amount of highly refined cellulose pulp has been removed by the fractionation in order to obtain the FD-HRC.

The FD-HRC has a Schopper-Riegler (SR) number in the range of 80-100 determined by standard ISO 5267-1. In some embodiments, the FD-HRC has a Schopper-Riegler (SR) number in the range of 85-98, preferably in the range of 90-97, as determined by standard ISO 5267-1.

In some embodiments, the FD-HRC comprises or consists of a microfibrillated cellulose (MFC) which has been fractionated to remove a portion of the finest cellulosic particles and/or dissolved and colloidal substances. The removal changes the particle size distribution such that the fractionated MFC has a lower portion of the finest cellulosic particles and/or dissolved and colloidal substances than the unfractionated MFC.

Microfibrillated cellulose (MFC) shall in the context of the patent application be understood to mean a cellulose particle, fiber or fibril having a width or diameter of from 20 nm to 1000 nm.

Various methods exist to make MFC, such as single or multiple pass refining, pre-hydrolysis followed by refining or high shear disintegration or liberation of fibrils. One or several pre-treatment steps is usually required in order to make MFC manufacturing both energy efficient and sustainable. The cellulose fibers of the pulp used when producing MFC may thus be native or pre-treated enzymatically or chemically, for example to reduce the quantity of hemicellulose or lignin. The cellulose fibers may be chemically modified before fibrillation, wherein the cellulose molecules contain functional groups other (or more) than found in the original cellulose. Such groups include, among others, carboxymethyl (CM), aldehyde and/or carboxyl groups (cellulose obtained by N-oxyl mediated oxidation, for example “TEMPO”), or quaternary ammonium (cationic cellulose). After being modified or oxidized in one of the above-described methods, it is easier to disintegrate the fibers into MFC.

MFC can be produced from wood cellulose fibers, both from hardwood or softwood fibers. It can also be made from microbial sources, agricultural fibers such as wheat straw pulp, bamboo, bagasse, or other non-wood fiber sources. It can be made from pulp, including pulp from virgin fiber, e.g. mechanical, chemical and/or thermomechanical pulps. It can also be made from broke or recycled paper.

In some embodiments, the FD-HRC is obtained from a chemical pulp, preferably a kraft pulp. The kraft pulp may be a bleached or unbleached kraft pulp, preferably a bleached kraft pulp. The FD-HRC can be produced from different raw materials, for example softwood pulp or hardwood pulp, or a mixture thereof. In preferred embodiments, the FD-HRC is obtained from a softwood pulp. In some embodiments, the FD-HRC is substantially free from lignin, preferably the FD-HRC has a lignin content below 10% by weight, based on the total dry weight of the FD-HRC. In some embodiments, the FD-HRC has a hemicellulose content in the range of 10-30% by weight, based on the total dry weight of the pulp FD-HRC.

The FD-HRC preferably has a relatively high amount of long fibers, i.e. of fibers having a length>0.2 mm. In some embodiments, the FD-HRC has an amount of long (>0.2 mm) fibers of at least 8 million fibers per gram (based on dry weight). In some embodiments, the FD-HRC has an amount of long (>0.2 mm) fibers of at least 10 million fibers per gram (based on dry weight), preferably at least 12 million fibers per gram (based on dry weight), and more preferably at least 14 million fibers per gram (based on dry weight). Unless otherwise stated, the amount of fibers having a length>0.2 mm is determined using the Fiber Tester Plus instrument (L&W/ABB). A known sample weight of 0.100 g is used for each sample and the amount of fibers having a length>0.2 mm (million fibers per gram) is calculated using the following formula: Million fibers per gram=(No. fibers in sample)/(Sample weight)/1 000 000=(Property ID 3141)/property ID 3136)/1 000 000.

In some embodiments, the FD-HRC has a fiber length Lc(n) FS5 ISO in the range of 0.25-0.7 mm, preferably in the range of 0.3-0.6 mm and more preferably in the range of 0.4-0.6 mm. The fiber length Lc(n) FS5 ISO can be determined using an FS5 optical fiber analyzer (Valmet).

The FD-HRC has been subjected to fractionation to remove some of the fines. Due to the fractionation, the FD-HRC preferably has a relatively low Fines A value, particularly in relation to the Fines B value, as determined using an FS5 optical fiber analyzer. In some embodiments, the FD-HRC has a Fines A value at least 1 percentage point lower than the Fines B value. In some embodiments, the FD-HRC has a Fines A value at least 1.5 percentage point(s) lower, preferably at least 2 percentage point(s) lower and more preferably in the range of 2-15 percentage point(s) lower, than the Fines B value, wherein the Fines A value and Fines B value are determined using an FS5 optical fiber analyzer. The relation between the amount of Fines A and Fines B has been found to be important to both improve the dewatering properties and the strength properties. The amount of Fines B should be more than the amount of Fines A in order to achieve the desired properties.

In some embodiments, the FD-HRC has a Fines A value below 45%, preferably below 43%, and more preferably below 40%. It may be preferred that the Fines A value is between 5-45%, preferably between 10-43% and even more preferred between 20-40%. It is preferred not to remove all Fines A material. The FD-HRC, having both a high SR value, a high amount of fibers having a length>0.2 mm, and a Fines A value below 46%, has been found to be very useful for manufacturing gas barrier films as it gives faster dewatering and at the same time retains or improves the film barrier and retains tensile strength properties as compared to the corresponding unfractionated HRC.

As mentioned, the gas barrier film may be comprised of a combination of the FD-HRC and one or more other components.

In some embodiments, the gas barrier film further comprises 0.01-10 wt % of a dispersing agent. The dispersing agent may for example be selected from the group consisting of anionic, nonionic or amphoteric polysaccharides (such as water soluble starch, CMC or cellulose derivatives), proteins, alginates, hemicelluloses and derivatives thereof, polyacrylic acids, acrylate copolymers, sodium salts of acrylic acids, polyacrylic acids, polyacrylamides, maleic acid, polymaleic acids, sodium malonate, sodium succinate, sodium malate, sodium glutamate, polyphosphates, sodium hexametaphosphate (SHMP), polyvinyl alcohol, polyvinyl acetate, PVOH/Ac, and sodium n-silicate, or combinations thereof.

In some embodiments, the gas barrier film further comprises 0.1-10 wt % of a starch.

In some embodiments, the cellulose-based gas barrier film has a dry grammage in the range of 10-100 gsm. In some embodiments, the cellulose-based gas barrier film has a dry grammage in the range of 10-80 gsm, preferably in the range of 15-70 gsm, and more preferably in the range of 20-60 gsm.

The gas barrier film may also be combined with one or more coating layers to further improve the gas barrier properties, or other barrier properties of the film. The coating layers may be single, double or multilayer coatings on one or both sides of the gas barrier film.

In some embodiments, the cellulose-based gas barrier film further comprises a barrier polymer coating layer. The barrier polymer coating layer may for example comprise a polyvinyl alcohol (PVOH) layer.

In some embodiments, the cellulose-based gas barrier film further comprises a vacuum deposited coating layer. The vacuum deposited coating layer may be organic or inorganic. In some embodiments, the vacuum deposited coating layer may comprise a metal or metal oxide layer.

In some embodiments, the cellulose-based gas barrier film has an oxygen transfer rate (OTR), measured according to the standard ASTM D-3985 at 50% relative humidity and 23° C., of less than 100 cc/m²/day, preferably less than 50 cc/m²/day, more preferably less than 10 cc/m²/day.

The present invention further relates to a method for manufacturing a cellulose-based gas barrier film according to the first aspect.

Thus, according to a second aspect illustrated herein, there is provided a method for manufacturing a cellulose-based gas barrier film, said method comprising:

a) providing a highly refined cellulose pulp (HRC) suspension comprising at least 50 wt % of HRC based on dry weight of the suspension, wherein said HRC has a Schopper-Riegler (SR) number in the range of 80-100 as determined by standard ISO 5267-1;

b) subjecting the HRC suspension to fractionation to obtain a fines-depleted highly refined cellulose pulp (FD-HRC) suspension; and

c) forming a web of the FD-HRC suspension and dewatering the web to obtain a cellulose-based gas barrier film;

wherein said FD-HRC has a Schopper-Riegler (SR) number in the range of 80-100 as determined by standard ISO 5267-1,

wherein said FD-HRC has an amount of long (>0.2 mm) fibers of at least 8 million fibers per gram (based on dry weight), and

wherein said FD-HRC has a Fines A value below 46%, wherein the Fines A value is determined using an FS5 optical fiber analyzer.

The HRC and FD-HRC of the second aspect may be further defined as described above with reference to the first aspect.

In some embodiments, the HRC of the HRC suspension, i.e. the starting material, is a microfibrillated cellulose (MFC).

In some embodiments, the HRC suspension comprises at least 70 wt %, preferably at least 90 wt %, of the FD-HRC based on dry weight of the suspension.

In some embodiments, the HRC suspension further comprises 0.01-10 wt % of a dispersing agent.

The starting material of the inventive method is a highly refined cellulose pulp suspension. Refining, or beating, of cellulose pulps refers to mechanical treatment and modification of the cellulose fibers in order to provide them with desired properties. The highly refined cellulose pulp suspension is an aqueous suspension comprising a water-suspended mixture of cellulose based fibrous material and optionally non-fibrous additives. The pulp suspension can be produced from different raw materials, for example selected from the group consisting of bleached or unbleached softwood pulp or hardwood pulp, Kraft pulp, pressurized groundwood pulp (PGW), thermomechanical (TMP), chemi-thermomechanical pulp (CTMP), neutral sulfite semi chemical pulp (NSSC), or a mixture thereof.

In some embodiments, the HRC is obtained from a chemical pulp.

The HRC may be obtained from a dried or never dried pulp. In some embodiments, the HRC is obtained from a chemical pulp which has been dried. In some embodiments, the HRC is obtained from a never dried chemical pulp.

The term highly refined cellulose pulp as used herein refers to a cellulose pulp having a Schopper-Riegler (SR) number in the range of 80-100 determined by standard ISO 5267-1. In some embodiments, the HRC has a Schopper-Riegler (SR) number in the range of 85-98, preferably in the range of 90-97, as determined by standard ISO 5267-1.

In some embodiments, the HRC of the HRC suspension has an amount of long (>0.2 mm) fibers of at least 10 million fibers per gram (based on dry weight), preferably at least 12 million fibers per gram (based on dry weight), and more preferably at least 14 million fibers per gram (based on dry weight).

In some embodiments, the HRC of the HRC suspension has a Fiber length Lc (n) FS5 ISO in the range of 0.25-0.7 mm, preferably in the range of 0.3-0.6 mm and more preferably in the range of 0.4-0.6 mm.

Any suitable fractionation method known in the art may be used for the fractionation of the HRC to remove some of the fines. Examples of fractionation methods include, but are not limited to, flotation, settling, decanting, belt filtration, wire filtration, membrane filtration, centrifugation (e.g. using hydrocyclones) and pressure screening.

Many existing pulp fractionation methods are optimized for fractionation of normal pulp suspensions into coarse and fine fractions. In the present disclosure, wherein the starting material is a highly refined cellulose pulp or even a microfibrillated cellulose, the fractionation involves removal, or partial removal, of the finest fraction of cellulose fines. The fractionation may further lead to removal of fine particles of non-cellulosic materials, e.g. inorganic materials, as well as dissolved materials.

Hydrocyclones fractionate solids based on surface area. Experimental studies have shown that hydrocyclones separate fibers according to the specific surface area, specific volume and cell wall thickness. A problem with hydrocyclones is that they are less efficient at higher solids content, such as >0.9 wt %, due to flocculation.

Pressure screens fractionate solids based on size and flexibility. Particle acceptance is determined by fiber flexibility, length, and thickness in that order. Fibers of equal length are accepted by flexibility. Chemical fibers are more readily accepted than stiff mechanical fibers. Fibers of different length are accepted by length, and shorter fibers are accepted more readily than long fibers. In screening, lower solids makes it possible to use finer slits but this requires larger machinery and is thus less economically attractive.

In some embodiments, the fractionation is performed using a RotoWash (Andritz) In the RotoWash the pulp suspension flows over a finely perforated plate with an open area of up to 18%. The RotoWash uses a combination of a basket and parabolic rotor create optimum flow conditions. Foils on the rotor induce a strong pressure pulse and effect excellent fractionation of the pulp.

In a preferred embodiment, the fractionation is performed using a high-speed belt filter, also known as a belt filter press, normally used in washing conventional pulp suspensions for papermaking, particularly for recycled papers grades such as newspaper and magazine paper containing high amount of fillers and pigments.

A high-speed belt filter is a machine designed for treating pulps to increase consistency by removing water. The pulp and paper making industry has for many years made regular use of such machines for washing and thickening pulp and paper stock, usually for storage or other temporary treatment purposes.

Although high-speed belt filters have been used for washing and thickening conventional pulps used in papermaking, they have not previously been used for fractionation of highly refined cellulose pulps in accordance with the present invention.

Exemplary belt filters include Double Wire Press (available from Andritz-Ahlstrom); BDP (available from Baker Process); Turbodrain (1 wire), Winkelpress (2 wires), and Cascade S (both types in series) (available from Bellmer and Corner); HC Press, Gap Washer, and TwinWire (with Paraformer headbox) (available from Metso Paper/Fiber and Phoenix Process Equipment); Salter Belt Press (available from Salter); DNT Washer (available from Thermo Black Clawson); VarioSplit (available from Voith Paper); and Osprey (available from William Jones, London).

One preferred design for use in the inventive method is the VarioSplit type apparatus. German OS 30 05 681 and the publication “VarioSplit, eine neue Maschine zur Verbesserung von AP-Rohstoffen” in “Wochenblatt für Papierfabrikation” volume 21/1981 p. 787-796 describe the VarioSplit, which is suitable for washing aqueous fiber stock suspensions obtained from waste paper and which also can be applied for thickening of such suspensions (OS 30 05 681 column 2, lines 30 to 34, column 2, line 68 to column 3, line 41). A typical stock suspension to be treated is stated to have a consistency of less than 1.5%, preferably 0.4 to 0.8% (column 3, lines 61 to 67).

The “VarioSplit” apparatus comprises, according to a preferred embodiment, an endless wire or filter band having an outer surface which co-operates with a substantial portion of the surface of a rotatable cylinder, a flat jet nozzle forming a flat suspension jet which is introduced into a substantially wedge-shaped intermediate space between the outer surface of the wire band and the cylinder, a take-off roll, a catch container for the pressed-out water, means for collecting the thickened pulp and three guide rolls (column 2, last line to column 3, line 41 and the single figure). For washing a stock suspension, the apparatus is operated in such a way that the fiber web formed between the outer surface of the wire band and the cylinder has a weight of less than 100 g/m², preferably 30 to 70 g/m², and the wire speed and the circumferential speed of the cylinder is in the order of 400 to 1200 m/min (claim 1 and column 3, last line to column 4, line 8).

The use of a high-speed belt filter in the inventive method allows for efficient high-capacity fractionation of highly refined cellulose pulps. The use of a high-speed belt filter allows for fractionation of highly refined cellulose pulps at a scale and speed sufficient for commercial production.

In some embodiments, the high-speed belt filter comprises a wire belt having an air permeability above 4000 m³/m²/hour at 100 Pa.

In some embodiments, the belt of the high-speed belt filter moves at rate of at least 50 m/min, preferably at least 100 m/min, and more preferably at least 200 m/min.

In some embodiments, the dwell time of the highly refined cellulose pulp on the belt is below 7 seconds, preferably below 5 seconds, more preferably below 3 seconds.

In some embodiments, the high-speed belt filter is a single-wire or twin-wire type belt filter. A single-wire type belt filter drains the water from the pulp suspension through a single wire. A twin-wire type belt filter, sandwiches the pulp between two wires, allowing drainage through both wires.

The HRC suspension for use with the inventive method may preferably have a consistency in the range of 0.1-5 wt %. A consistency in the range of 0.1-2.5 wt % has been found to provide a suitable balance between grammage and efficient drainage of water together with cellulose fines. In some embodiments, the consistency of the HRC suspension provided in step a) is in the range of 0.1-2.5 wt %, preferably in the range of 0.1-1.5 wt %, preferably in the range of 0.1-1 wt %, preferably in the range of 0.2-0.8 wt %, more preferably in the range of 0.2-0.6 wt %.

In some embodiments, the HRC suspension is subjected to dilution before being subjected to the fractionation. When diluting the HRC suspension it is important that the liquid used for the dilution, preferably water or an aqueous solution, does not add additional fines to the suspension to any significant extent as this would counteract the purpose of the fractionation. Accordingly, the liquid used for the dilution should preferably be a pure liquid, or at least have a low total solid content. In some embodiments, the liquid used for dilution has a total solid content below 1 wt %, preferably below 0.5 wt %, and more preferably below 0.1 wt %. In some embodiments, the liquid used for dilution has a temperature in the range of 30-90° C., preferably in the range of 35-75° C. In some embodiments, the liquid used for dilution has a pH in the range of 4-10, preferably in the range of 5-9.

In some embodiments, the total solid content of the HRC suspension is reduced by 0.2-4 wt %, preferably by 1-3 wt %, and more preferably by 1.5-2.5 wt %, by the fractionation.

Due to the removal of fine material during the fractionation, it is expected that the FD-HRC will exhibit lower water retention than the HRC. However, it was surprisingly found that the Schopper-Riegler (SR) number of the FD-HRC remained in the same range as the Schopper-Riegler (SR) number of the HRC. In some embodiments, the FD-HRC has a Schopper-Riegler (SR) number in the range of 85-98, preferably in the range of 90-97, as determined by standard ISO 5267-1.

In some embodiments, the FD-HRC has a lower water retention value (WRV) than the HRC provided in step a).

The FD-HRC preferably has a relatively high amount of long fibers, i.e. of fibers having a length >0.2 mm. In some embodiments, the FD-HRC has an amount of long (>0.2 mm) fibers of at least 8 million fibers per gram (based on dry weight). In some embodiments, the FD-HRC has an amount of long (>0.2 mm) fibers of at least 10 million fibers per gram (based on dry weight), preferably at least 12 million fibers per gram (based on dry weight), and more preferably at least 14 million fibers per gram (based on dry weight).

In some embodiments, the FD-HRC has a Fiber length Lc (n) FS5 ISO in the range of 0.25-0.7 mm, preferably in the range of 0.3-0.6 mm and more preferably in the range of 0.4-0.6 mm.

The fractionation leads to a reduction of the Fines A and/or Fines B values of the HRC. In some embodiments, the Fines A value of the FD-HRC is at least 3 percentage point(s) lower, preferably at least 5 percentage point(s) lower, and more preferably at least 7 percentage point(s) lower, than the Fines A value of the HRC. In some embodiments, the Fines B value of the FD-HRC is at least 3 percentage point(s) lower, preferably at least 5 percentage point(s) lower, and more preferably at least 7 percentage point(s) lower, than the Fines B value of the HRC.

It has further been found that the fractionation leads to a greater reduction of the Fines A value than of the Fines B value. In some embodiments, the FD-HRC has a Fines A value at least 1 percentage point(s) lower, preferably at least 2 percentage point(s) lower and more preferably in the range of 2-15 percentage point(s) lower, than the Fines B value, wherein the Fines A value and Fines B value are determined using an FS5 optical fiber analyzer.

In some embodiments, the FD-HRC has a Fines A value below 45%, preferably below 43%, and more preferably below 40%.

In some embodiments, the FD-HRC is subjected to gentle shearing or refining after the fractionation in order to re-activate the dewatered and fractionated pulp. In some embodiments, the FD-HRC is subjected to gentle shearing or refining at 5-75 kWh/t, preferably 5-40 kWh/t. Without wishing to be bound to any specific theories, it is also believed that this mechanical re-activation stabilizes the refined fiber and pulp and prevents agglomeration and wet hornification.

The inventive method further comprises forming a web of the FD-HRC suspension and dewatering the web to obtain a cellulose-based gas barrier film. Such cellulose-based gas barrier films may also exhibit good aroma barrier and/or good grease resistance properties.

In some embodiments, the film is made by applying the FD-HRC suspension on a non-porous substrate, such as a metal belt or plastic belt, forming a web followed by dewatering of the web by press dewatering.

In some embodiments, the film is made by applying the FD-HRC suspension on a porous substrate forming a web followed by dewatering of the web by draining water through the substrate for forming the film. Formation of the web can be accomplished e.g. by use of a paper-or paperboard machine type of process. The porous substrate may for example be a membrane or wire fabric or it can be a paper or paperboard substrate.

Although different arrangements for performing the forming and dewatering steps of the inventive method could be contemplated by the skilled person, the inventive method may advantageously be performed in a paper machine, more preferably in a Fourdrinier paper machine.

A paper machine (or paper-making machine) is an industrial machine which is used in the pulp and paper industry to create paper in large quantities at high speed. Modern paper-making machines are typically based on the principles of the Fourdrinier Machine, which uses a moving woven mesh, a “wire”, to create a continuous web by filtering out the fibers held in a pulp suspension and producing a continuously moving wet web of fiber. This wet web is dried in the machine to produce paper or film.

The forming and dewatering steps of the inventive method are preferably performed at the forming section of the paper machine, commonly called the wet end. A wet web is formed on a wire in the forming section of the paper machine.

The wire used in the inventive method preferably has relatively high porosity in order to allow fast dewatering and high drainage capacity. The air permeability of the wire is preferably above 5000 m³/m²/hour at 100 Pa. The wire preferably has a high fibre support index (F.S.I), typically above 190 so that fine material does not penetrate into the structure and to cause less wire markings, and a coarse and open back side. The wire section of the paper machine may have various dewatering devices such as blade, table and/or foil elements, suction boxes, friction less dewatering, ultra-sound assisted dewatering, couch rolls, or a dandy roll.

Following initial dewatering, the web may subsequently be further dewatered and dried to obtain the gas barrier film. The resulting gas barrier film preferably has a dry solids content above 90 wt %.

The further dewatering typically comprises pressing the web to squeeze out as much water as possible. The further dewatering may for example include passing the formed web through a press section of a paper machine, where the web passes between large rolls loaded under high pressure to squeeze out as much water as possible. In some embodiments the further dewatering comprises passing the web through one or more shoe presses. The removed water is typically received by a fabric or felt. In some embodiments, the dry solids content of the film after the further dewatering is in the range of 15-48 wt %, preferably in the range of 18-40 wt %, and more preferably in the range of 22-35 wt %.

The optional drying may for example include drying the web by passing the web around a series of heated drying cylinders. Drying may also include air drying, radiation drying and impingement drying. In some embodiments, the drying comprises drying the web on a Yankee cylinder. The Yankee cylinder can also be used to produce a glazed surface on the finished film. Drying may typically remove the water content down to a level of about 1-15 wt %, preferably to about 2-10 wt %.

The inventive method allows for efficient manufacturing a barrier film comprising highly refined cellulose pulp in a paper machine type of process. Such films have been found to be very useful, e.g., as gas barrier films in packaging applications. The films can be used to replace conventional barrier films, such as synthetic polymer films or aluminum foils which reduce the recyclability of paper or paperboard packaging products. The inventive gas barrier films have high repulpability, providing for high recyclability of the films and paper or paperboard packaging products comprising the films.

In some embodiments, the cellulose-based gas barrier film has a dry grammage in the range of 10-100 gsm. In some embodiments, the cellulose-based gas barrier film has a dry grammage in the range of 10-80 gsm, preferably in the range of 15-70 gsm, and more preferably in the range of 20-60 gsm.

In some embodiments, the cellulose-based gas barrier film has a thickness in the range of 15-100 μm, preferably in the range of 20-85 μm, and more preferably in the range of 25-60 μm.

In some embodiments, the cellulose-based gas barrier film has a density above 600 kg/m³ and preferably in the range of 700-1400 kg/m³. Preferably the cellulose-based gas barrier film has a density above 600 kg/m³ and preferably in the range of 700-1400 kg/m³ when ash content of the film is less than 5%.

The gas barrier film can be used as such, or it can be combined with one or more other layers to form a multilayer structure. The film is for example useful as a barrier layer in a paperboard based packaging material. The film may also constitute a barrier layer in glassine, greaseproof paper or a thin packaging paper.

In some embodiments, the barrier film is formed directly on a on a porous substrate in the form of a dry or wet paper or paperboard substrate. Thus, in some embodiments, the method for manufacturing a cellulose-based gas barrier film comprises the step c) forming a web of the FD-HRC suspension on a dry or wet paper or paperboard substrate and dewatering the web to obtain a multilayer structure comprising the paper or paperboard substrate and the cellulose-based gas barrier film. The dry or wet paper or paperboard substrate may comprise at least 50% by dry weight of cellulose based fibrous material having an SR

(Schopper-Riegler) value in the range of 18-75.

In some embodiments, the formed cellulose-based gas barrier film is further coated with a barrier polymer coating layer. The barrier polymer coating layer may for example comprise a polyvinyl alcohol (PVOH) layer.

In some embodiments, the cellulose-based gas barrier film is further coated with a vacuum deposition coating layer. The vacuum deposition coating layer may for example comprise a metal or metal oxide layer.

The inventive gas barrier films are useful, e.g., as gas barrier films in packaging applications. The films can be used to replace conventional barrier films, such as synthetic polymer films or aluminum foils which reduce the recyclability of paper or paperboard packaging products. The inventive films have high repulpability, providing for high recyclability of the films and paper or paperboard packaging products comprising the films.

Thus, according to a third aspect illustrated herein, there is provided a paper or paperboard based packaging material comprising:

i) a paper or paperboard based substrate; and

ii) a cellulose-based gas barrier film according the first aspect described herein, or obtained by a method according to the second aspect described herein.

While the invention has been described with reference to various exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

### EXAMPLES

### Example 1—Fibrillated Pulp (Comparative)

A highly fibrillated bleached kraft pulp (FP) was prepared by low consistency fibrillation of bleached softwood kraft pulp to a drainage resistance of °SR 95.5.

Fines A and Fines B values of the highly fibrillated bleached kraft pulp were determined with Valmet FS5 Fiber Image Analyzer to be 47 and 47, respectively.

Dewatering time of the pulp was measured according to the following method. MFC suspension was diluted to 0.1 wt % consistency with reverse osmosis purified water and subjected to rod mixing (30 s) and magnetic stirring (2 min). 125.6 g of the diluted and mixed suspension was poured into the funnel of a vacuum filtration device equipped with a membrane filter (Durapore®, 0.65 um pore size). The diameter of the round filtration area was 73 mm. Immediately after pouring the suspension into the funnel, vacuum was switched on and time recording started. The dewatering time(s) recorded during the filtration was the time that was needed for all the visible water to disappear from top of the filtration cake. The wet filtration cake was removed from the filtration device together with the membrane filter and placed in between two blotting papers. The filtration cake (i.e. film) was then couched, subjected to wet pressing at 410 kPa for 5 minutes and dried in a drum dryer at 80° C. for at least 90 minutes. The dried film was weighed after conditioning in 23° C./50% RH. To obtain a specific dewatering value (s/g), the recorded dewatering time(s) was divided by the weight of the dried film (g). Four duplicates were done for each sample.

The highly fibrillated bleached kraft pulp was also used to make a thin web on a pilot paper machine (pilot-PM) starting at a consistency of 0.13 wt %, a pH of 7.4 and an SR value of 95.5.

### Example 2—Fibrillated Pulp With Fines Removed

A part of the highly fibrillated bleached kraft pulp (FP) was then diluted with clean water (substantially free from organic material and other chemicals) and subjected to a fractionation process on the wire of a high-speed belt filter, whereby a portion of the fines was removed from the fibrillated pulp. The permeability of the wire was 5700 m³/m²/hour at 100 Pa. The fractionated pulp was subjected to a post refining of 20 kWh/t. The resulting fines-depleted highly fibrillated bleached kraft pulp is referred to as “FP+FR”.

After fractionation, the Fines A and Fines B values were reduced to 36 and 38%, respectively. The SR value remained on high level (SR=95) even after the fractionation.

Dewatering time of the pulp was measured as in Example 1.

The fines-depleted highly fibrillated bleached kraft pulp was used to make a thin web on the pilot-PM starting at a consistency of 0.13 wt %, a pH of 7.4 and an SR value of 95.

A significant reduction in the dewatering time was seen, which also was detected as significantly lower vacuum needed on the wire (about 50% less vacuum needed to drain the furnish on the wire).

### Example 3—Fibrillated Pulp With Added Dispersing Agent (Comparative)

A highly fibrillated bleached kraft pulp was prepared as in Example 1 and 1.0 kg/tn of a dispersing agent (anionic polyacrylamide, Fennopol A8842) was added to the pulp suspension during a post-refining of 20 kWh/t. The resulting highly fibrillated bleached kraft pulp with dispersing agent is referred to as “FP+dispersing agent”.

Dewatering time of the pulp was measured as in Example 1.

The dewatering time increased, i.e. it became more difficult to dewater the web, indicating a more dense film. The gas barrier properties determined for the sample with the dispersing agent had much greater variations and were not even possible to measure at higher relative humidity and temperature. This confirms that the use of a dispersing agent can have negative effect since the film is damaged during the dewatering. Most likely, the defects would be even further exacerbated at higher machine speeds, since higher vacuum is needed and water is drained faster.

### Example 4—Fibrillated Pulp With Fines Removed With Added Dispersing Agent

A fines-depleted highly fibrillated bleached kraft pulp was prepared as in Example 2 and 1.0 kg/tn of a dispersing agent (anionic polyacrylamide, Fennopol A8842) was added to the fractionated pulp suspension during a post-refining of 20 kWh/t.

The resulting highly fibrillated bleached kraft pulp with dispersing agent is referred to as “FP+FR+dispersing agent”.

Dewatering time of the pulp was measured as in Example 1.

The dewatering time was found to be even faster than in Example 2, which was surprising in view of the result in Example 3.

The OTR values determined at 23° C./RH 50 and 38° C./85% RH were both measurable, but especially interesting is that values determined at 38° C./85% RH were fairly low, despite the fact that dewatering time was reduced so significantly. Also, in this case, the vacuum needed on the pilot paper machine was about 50% less compared to the reference. The vacuum level is adjusted by following the water line for the wet furnish on the wire.

The results of Examples 1-4 are presented in Tables I and II.

TABLE I
Recipes and furnish properties

| | Unit | Ex. 1 | Ex. 2 | Ex. 3 | Ex. 4 |
|---|---|---|---|---|---|
| FP | % | 100 | | | |
| FP + FR | % | | 100 | | |
| FP + dispersing agent | % | | | 100 | |
| FP + FR + dispersing agent | % | | | | 100 |
| Drainage resistance | °SR | 95.5 | 95.0 | | |
| pH | | 7.2 | 6.6 | | |
| Amount of fibers >0.2 mm | Million | 19.8 | 17.2 | 18.9 | 17.9 |
| | fibers/g | | | | |
| Fiber Length Lc(n) FS5 | mm | 0.46 | 0.49 | | |
| ISO | | | | | |
| Fiber Length Lc(l) FS5 | mm | 0.71 | 0.75 | | |
| ISO | | | | | |
| Fiber curl FS5 | % | 12.7 | 10.6 | | |
| Fines A FS5 | % | 47 | 36 | | |
| Fines B FS5 | % | 47 | 38 | | |
| Dewatering time | s/g | 962 | 779 | 1153 | 730 |

TABLE II
Measured properties of the sheets

| | Unit | Ex. 1 | Ex. 2 | Ex. 3 | Ex. 4 |
|---|---|---|---|---|---|
| Grammage | g/m² | 31 | 30 | 29 | 32 |
| Thickness | μm | 40 | 41 | 38 | 42 |
| Cobb Unger 30 s, TS | g/m² | 1.2 | 1.5 | 1.6 | 1.6 |
| Specific formation | g\hat{ }0.5/m | 0.5 | 0.65 | 0.54 | 0.59 |
| Tensile index, MD | Nm/g | 96.9 | 93.0 | 97.6 | 96.8 |
| Tensile index, CD | Nm/g | 61.8 | 63.5 | 65.3 | 63.8 |
| Tensile Index, GM | Nm/g | 77.4 | 76.8 | 79.8 | 78.6 |
| OTR, 23° C./RH 50 | | 3.8 | 2.1 | 746 | 44 |
| OTR, 38° C./RH 85 | | 73 | 43 | x | 90 |

The fines removal improves dewatering significantly. Surprisingly, the fines removal did not impact the drainage resistance value measured according to the

Schopper-Riegler method, but had a significant effect on the dewatering time and vacuum needed on the pilot paper machine to dewater the web.

### Example 5—Effect of Washing (Comparative)

In this case, the fibrillated pulp was subjected to washing by removing water free from fibrils and fines. The sample was diluted to 0.5 wt % and subjected to centrifugation (15557 rcf, 15 min). The supernatant was removed from the centrifuge tubes and the remaining fiber cake was re-dispersed to ˜0.5 wt % with clean water and then centrifugation was repeated, and the supernatant was again removed. The remaining fibrillated pulp phase was redispersed to ˜0.5 wt %.

The washing procedure had no effect on dewatering rate or on OTR properties of the film. This shows that the improvements obtained with the fractionation in Examples 2 and 4 are attributed to removal of fines, rather than dissolved colloidal (i.e. 1-100 nm) substances.

Unless stated otherwise, parameters of the furnishes and sheets were measured according to the following standards:

| | |
|---|---|
| Drainage resistance (tap water) | SCAN C19: 65 |
| Thickness single sheet | ISO 534: 2011 |
| Density single sheet | ISO 534: 2011 |
| Tensile strength (index) | ISO 1924-3: 2005 |
| Tensile stiffness (index) | ISO 1924-3: 2005 |
| OTR | ASTM D-3985 |

The amount of fibers having a length>0.2 mm was determined using the Fiber Tester Plus instrument (L&W/ABB). A known sample weight of 0.100 g is used for each sample and the amount of fibers having a length>0.2 mm (million fibers per gram) is calculated using the following formula: Million fibers per gram=(No. fibers in sample)/(Sample weight)/1 000 000=(Property ID 3141)/property ID 3136)/1 000 000.

Fiber Length Lc(n) ISO, Fiber Length Lc(l) ISO, Fiber curl, Fines A, and Fines B were determined using an FS5 optical fiber analyzer. “Fines A” refers to flake-like fines with a size under 0.2 mm (length<0.2 mm and width<0.2 mm). The projection area of the flake-like fines divided by the total fiber projection area*100%=Fines A. “Fines B” refers to lamella-like long fines having a width of less than 5 μm and a length over 0.2 mm. The length of these objects divided by the length of all objects with length>0.2 mm*100%=Fines B.

1. A cellulose-based gas barrier film, said cellulose-based gas barrier film comprising:
at least 50 wt % of a fines-depleted highly refined cellulose pulp (FD-HRC),
wherein said FD-HRC has a Schopper-Riegler (SR) number in a range of 80-100 as determined by standard ISO 5267-1,
wherein said FD-HRC has an amount of long (>0.2 mm) fibers of at least 8 million fibers per gram (based on a dry weight of the FD-HRC), and
wherein said FD-HRC has a Fines A value below 46%, wherein the Fines A value is determined using an FS5 optical fiber analyzer.

2. The cellulose-based gas barrier film according to claim 1, wherein said film comprises at least 70 wt % of the FD-HRC.

3. (canceled)

4. The cellulose-based gas barrier film according to claim 1, wherein said FD-HRC has a Schopper-Riegler (SR) number in a range of 85-98, as determined by standard ISO 5267-1.

5. The cellulose-based gas barrier film according to claim 1, wherein said amount of long (>0.2 mm) fibers is at least 10 million fibers per gram (based on the dry weight).

6. The cellulose-based gas barrier film according to claim 1, wherein said FD-HRC has a Fiber length Lc(n) FS5 ISO in a range of 0.25-0.7 mm.

7. The cellulose-based gas barrier film according to claim 1, wherein said FD-HRC has a Fines A value at least 1 percentage point lower than a Fines B value, wherein the Fines A value and Fines B value are determined using an FS5 optical fiber analyzer.

8. The cellulose-based gas barrier film according to claim 1, wherein said FD-HRC has a Fines A value below 45%.

9. (canceled)

10. (canceled)

11. The cellulose-based gas barrier film according to claim 1, further comprising:
a barrier polymer coating layer.

12. The cellulose-based gas barrier film according to claim 1, further comprising:
a vacuum deposited coating layer.

13. The cellulose-based gas barrier film according to claim 1, wherein the film has an oxygen transfer rate (OTR), measured according to the standard ASTM D-3985 at 50% relative humidity and 23° C., of less than 100 cc/m²/day.

14. A method for manufacturing a cellulose-based gas barrier film, said method comprising:
a) providing a highly refined cellulose pulp (HRC) suspension comprising at least 50 wt % of HRC based on a dry weight of the HRC suspension, wherein said HRC has a Schopper-Riegler (SR) number in a range of 80-100 as determined by standard ISO 5267-1;
b) subjecting the HRC suspension to fractionation to obtain a fines-depleted highly refined cellulose pulp (FD-HRC) suspension; and
c) forming a web of the FD-HRC suspension and dewatering the web to obtain a cellulose-based gas barrier film;
wherein said FD-HRC has a Schopper-Riegler (SR) number in a range of 80-100 as determined by standard ISO 5267-1,
wherein said FD-HRC has an amount of long (>0.2 mm) fibers of at least 8 million fibers per gram (based on a dry weight of the FD-HRC), and
wherein said FD-HRC has a Fines A value below 46%, wherein the Fines A value is determined using an FS5 optical fiber analyzer.

15. The method according to claim 14, wherein said HRC comprises a microfibrillated cellulose (MFC).

16. The method according to claim 14, wherein said HRC suspension comprises at least 70 wt % of the FD-HRC based on a dry weight of the HRC suspension.

17. (canceled)

18. (canceled)

19. (canceled)

20. The method according to claim 14, wherein said HRC has an amount of long (>0.2 mm) fibers of at least 10 million fibers per gram (based on a dry weight of the HRC).

21. The method according to claim 14, wherein said HRC has a Fiber length Lc (n) FS5 ISO in a range of 0.25-0.7 mm.

22. The method according to claim 14, wherein the HRC suspension is subjected to dilution before being subjected to the fractionation, wherein a liquid used for dilution has a total solid content below 1 wt %.

23. The method according to claim 14, wherein a total solid content of the HRC suspension is reduced by 0.2-4 wt % by the fractionation.

24. The method according to claim 14, wherein said FD-HRC has a Schopper-Riegler (SR) number in the a range of 85-98, as determined by standard ISO 5267-1.

25. The method according to claim 14, wherein said amount of long (>0.2 mm) fibers is at least 10 million fibers per gram (based on the dry weight).

26. The method according to claim 14, wherein said FD-HRC has a Fiber length Lc(n) FS5 ISO in a range of 0.25-0.7 mm.

27. The method according to claim 14, wherein said FD-HRC has a Fines A value at least 1 percentage point lower than a Fines B value, wherein the Fines A value and Fines B value are determined using an FS5 optical fiber analyzer.

28. The method according to claim 14, wherein said FD-HRC has a Fines A value below 45%.

29. (canceled)

30. A paper or paperboard based packaging material comprising:
i) a paper or paperboard based substrate; and
ii) the cellulose-based gas barrier film according to claim 1.
